(19) United States
(12) Patent Application Publication
(10) Pub. No.: US 2022/0218003 A1
(43) Pub. Date: Jul. 14, 2022

(54) SODA MAKER HAVING CONVENIENT GAS INTAKE AND DISCHARGE

(71) Applicant: Jinye GUAN, Guangzhou (CN)

(72) Inventor: Jinye GUAN, Guangzhou (CN)

(21) Appl. No.: 17/595,647

(22) PCT Filed: May 18, 2020
(86) PCT No.: PCT/CN2020/090845

§ 371 Date: Nov. 19, 2021

(30) Foreign Application Priority Data
Aug. 30, 2019 (CN) 201921441761.5

(51) Int. Cl. A23L 2/54; A47J 31/46; B01F 23/2361; B01F 23/237

(52) U.S. Cl. CPC A23L 2/54; A47J 31/461; A47J 31/4403; B01F 23/237621; B01F 23/2361

(57) ABSTRACT

A soda maker having convenient gas intake and discharge comprises main, auxiliary unit. Main unit comprises housing, base, carbon dioxide cylinder provided within the housing, gas intake main body provided at top of carbon dioxide cylinder, gas intake support, gas intake connecting rod, locking engagement member. The auxiliary unit comprises outer casing, auxiliary unit main body, water bottle, tapered ring, soda bottle. The auxiliary unit main body provides gas discharge valve and switch valve. The housing provides installation hole. The soda maker further comprises pivoting base having side and top opening. The pivoting base fixed within housing, pivoting plate passes through installation hole, half shaft is pivoted half shaft hole. While operation, positioning protrusion engages with operation positioning blind hole, axis of connecting part parallels to horizontal plane, gas discharge valve engages end plate of pivoting base, switch valve engages locking engagement member. The positioning protrusion engages gas discharge positioning blind hole. The structure enables auxiliary unit to rotate by specific angle when operation complete, automatic gas discharge achieves before soda bottle removal performed, very convenience.

### CROSS-REFERENCE TO RELATED APPLICATION(S)

This application is a 371 International Patent Application No. PCT/CN2020/090845, filed on May 18, 2020, which claims the priority and benefit of Chinese patent application number 201921441761.5, filed Aug. 30, 2019 with China National Intellectual Property Administration, the entire contents of which are incorporated herein by reference.

### TECHNICAL FIELD

The present invention relates to a soda maker.

### BACKGROUND

At present, in the prior art, a soda maker comprises a main unit and an auxiliary unit. The main unit comprises a housing, a base, a carbon dioxide cylinder provided within the housing, and a gas intake main body provided at the top of the carbon dioxide cylinder. The auxiliary unit comprises an outer casing, an auxiliary unit main body, a water bottle coupler, a tapered ring, and a soda bottle. The auxiliary unit main body is provided with a gas discharge valve. The outer casing is connected with the housing. The gas intake main body is connected with the gas intake assembly on the auxiliary unit main body, and a gas rod connected with the gas intake assembly extends into the soda bottle. When discharging gas, the gas discharge valve is operated, and then the soda bottle is removed. The existing problem is that when the soda bottle is removed, the gas discharge step needs to be operated first, and the operation is inconvenient.

### SUMMARY

The present Patent aims to provide a soda maker having convenient gas intake and discharge, which has the characteristics of convenient gas intake and discharge.

The present Patent is realized as follows: a soda maker having convenient gas intake and discharge, which comprises a main unit and an auxiliary unit, wherein the main unit comprises a housing, a base, a carbon dioxide cylinder provided within the housing, a gas intake main body provided at the top of the carbon dioxide cylinder, a gas intake support, a gas intake connecting rod, and a locking engagement member, the gas intake connecting rod is pivoted with the gas intake main body, the locking engagement member is pivoted with the gas intake support, the locking engagement member is engaged with the gas intake connecting rod; the auxiliary unit comprises an outer casing, an auxiliary unit main body, a water bottle coupler, a tapered ring, and a soda bottle, the auxiliary unit main body is provided with a gas discharge valve and a switch valve, the outer casing is connected with the housing, the gas intake main body is communicated with a gas intake assembly on the auxiliary unit main body, and a gas rod connected with the gas intake assembly extends into the soda bottle; wherein the housing is provided with an installation hole;

a connecting part is provided on the outer casing, two parallel pivoting plates are provided on the connecting part, and a half shaft and a positioning protrusion are provided on the pivoting plate;

the soda maker further comprises a pivoting base having a side opening and a top opening;

a half shaft hole, an operation positioning blind hole and a gas discharge positioning blind hole are provided on the side wall plate of the pivoting base;

the pivoting base is fixed within the housing, the pivoting plate passes through the installation hole, the half shaft is pivoted with the half shaft hole, during operation, the positioning protrusion is engaged with an operation positioning blind hole, an axis of the connecting part is parallel to a horizontal plane, the gas discharge valve is engaged with an end plate of the pivoting base, the switch valve is engaged with the locking engagement member, and the positioning protrusion is engaged with the gas discharge positioning blind hole.

According to the soda maker having convenient gas intake and discharge, the gas discharge valve comprises a gas discharge valve body, a gas discharge valve nut, a gas discharge valve rod, a gas discharge valve core and a pressure spring which are provided on the auxiliary unit main body, the closed end of the gas discharge valve body is provided with a valve core base and is connected with the cavity of the auxiliary unit main body, and the gas discharge valve body is provided with radial gas discharge holes;

the gas discharge valve rod comprises a driving rod part, a body part, a circular disc surrounding the body part and a stopper at the suspended end of the driving rod part;

the gas discharge nut comprises a cavity part, an internal thread part and a guide hole provided on the end plate;

the gas discharge valve core is provided at the end of the body part, the body part is in sliding fit with the gas discharge valve body, the circular disc is engaged with the end of the gas discharge valve body, the driving rod part extends through the pressure spring and the gas discharge nut, the circular disc is in sliding fit with the cavity part of the gas discharge nut, the pressure spring is in sliding fit with the circular disc and the end plate of the gas discharge nut, the driving rod part is in sliding fit with the guide hole; the driving rod part is embedded with a clamping groove on the end plate of the pivoting base, and the stopper is engaged with the end plate of the pivoting base;

during operation, the gas discharge valve core is embedded with the gas guide hole on the valve core base, the pressure spring is in an automatic state;

when discharging gas, the gas discharge valve core is separated from the gas guide hole on the valve core base, and the pressure spring is in a compressed state.

According to the soda maker having convenient gas intake and discharge, the operation positioning blind hole and the gas discharge positioning blind hole are communicated through an arc-shaped guide groove.

According to the soda maker having convenient gas intake and discharge, the connecting part is located in the installation hole, and there is a gap between the connecting part and the installation hole.

According to the soda maker having convenient gas intake and discharge, the switch valve comprises a switch valve body provided on the auxiliary unit main body, a switch valve core base provided in the switch valve body, a switch valve rod, a valve core, a pressure spring, a switch nut and a safety gas discharge device communicated with the switch valve body;

the switch valve rod comprises a head part and a rod part, and the switch nut comprises a cavity part, an external thread part and a valve rod hole;

the valve core is provided on the head of the switch valve rod, the valve core is engaged with the gas hole on the switch valve core base, the head is in sliding fit with the inner cavity of the switch valve body, the pressure spring is sleeved on the valve rod with one end engaged with the head of the switch valve rod and the other end engaged with the end plate of the cavity part of the switch nut, the switch valve rod extends out of the switch nut through the valve rod hole, and the switch valve rod is engaged with the locking engagement member.

According to the soda maker having convenient gas intake and discharge, the safety gas discharge device comprises a gas discharge cavity, a safety valve core base provided at the bottom of the gas discharge cavity, a pressure relief hole, a safety valve core, a valve rod, a pressure spring and a plug;

the safety valve core is provided on the head of the valve rod, the safety valve core is engaged with the safety valve core base, the plug is screwed with the internal thread part at the upper part of the gas discharge cavity, and the pressure spring is engaged with the head of the valve rod and the internal counterbore on the plug.

The present Patent relates to a soda maker having convenient gas intake and discharge. The structure of the present Patent enables the auxiliary unit to rotate by a specific angle and stop after an operation has ended, such that automatic gas discharge is achieved before a soda bottle removal step is performed, thereby providing operational convenience.

### BRIEF DESCRIPTION OF THE DRAWINGS

FIG. 1 is a perspective view of the present Patent.

FIG. 2 is a sectional view of the present Patent.

FIG. 3 is a view A-A of FIG. 2.

FIG. 4 is a view B-B of FIG. 2.

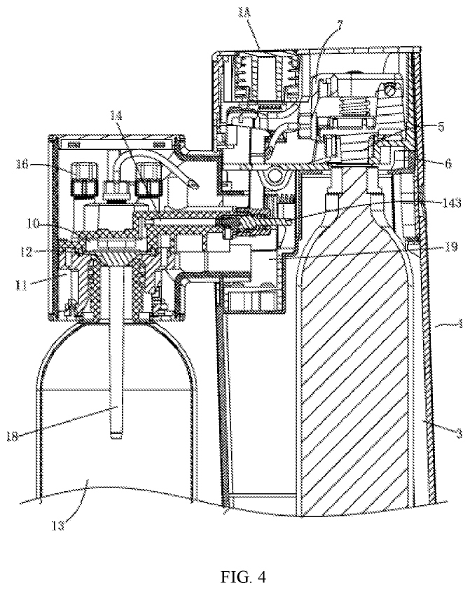

FIG. 5 is a first exploded perspective view of the present Patent.

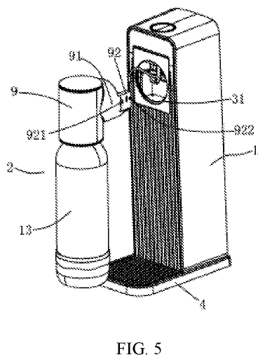

FIG. 6 is a second exploded perspective view of the present Patent.

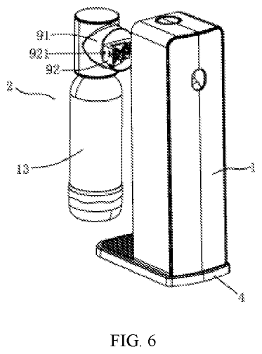

FIG. 7 is a third exploded perspective view of the present Patent.

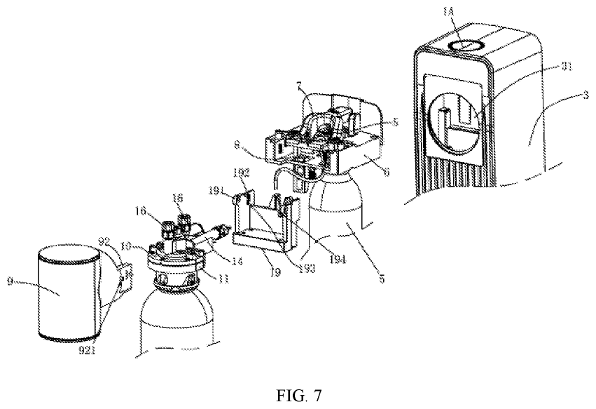

FIG. 8 is a fourth exploded perspective view of the present Patent.

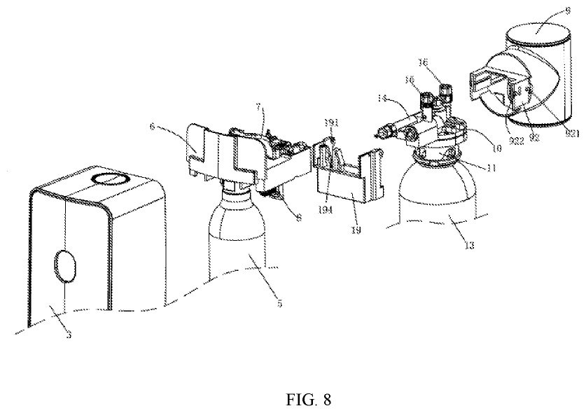

FIG. 9 is a partial perspective view of an auxiliary unit according to the present Patent.

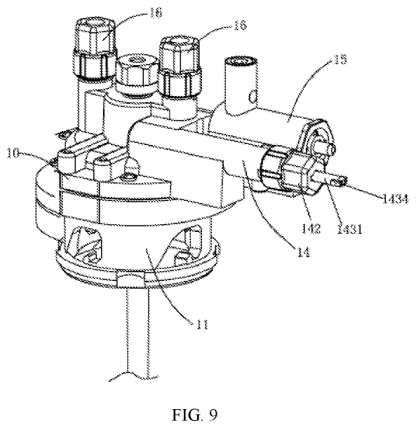

FIG. 10 is a perspective view of a support main body according to the present Patent.

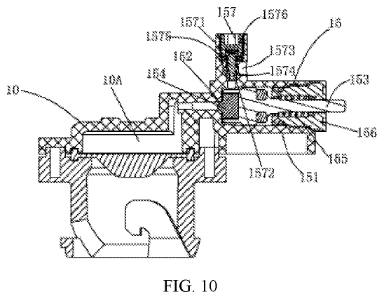

FIG. 11 is a first cross-sectional view of a support main body according to the present Patent.

FIG. 12 is a second cross-sectional view of a support main body according to the present Patent.

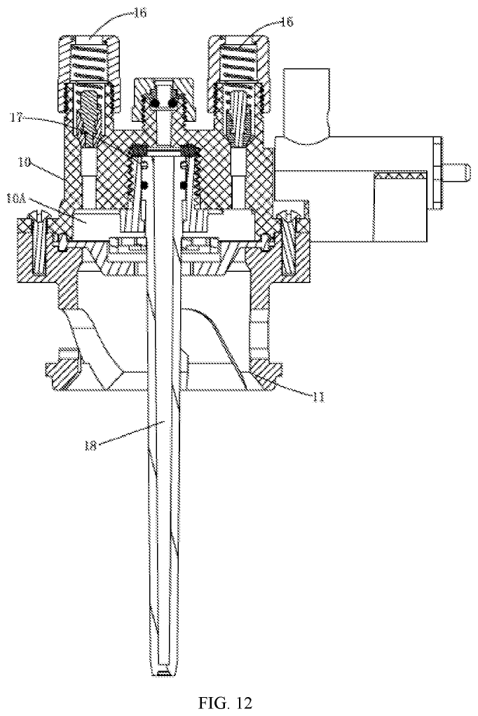

### DETAILED DESCRIPTION OF THE EMBODIMENTS

The present Patent will be further described with reference to the attached drawings.

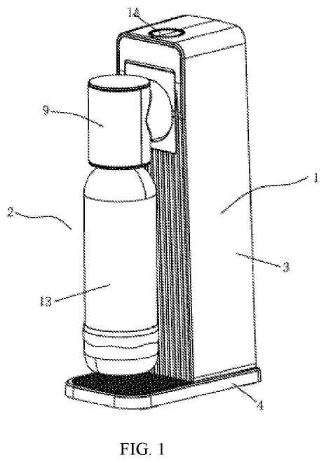

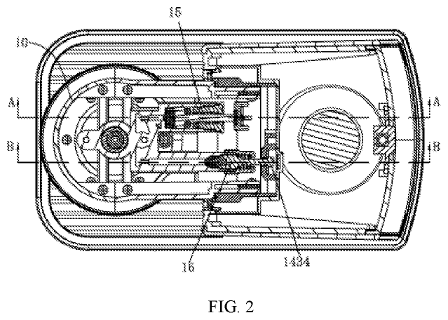

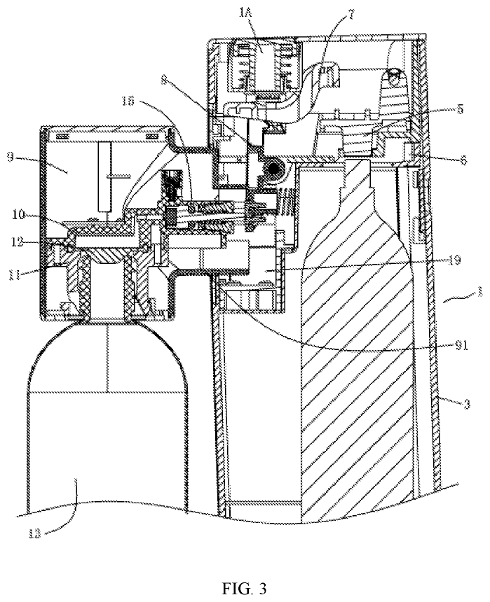

As shown in FIG. 1, FIG. 2 and FIG. 3, a soda maker having convenient gas intake and discharge comprises a main unit 1 and an auxiliary unit 2. The main unit 1 comprises a housing 3, a base 4, a carbon dioxide cylinder provided within the housing, a gas intake main body 5 provided at the top of the carbon dioxide cylinder, a gas intake support 6, a gas intake connecting rod 7, and a locking engagement member 8. The gas intake connecting rod 7 is pivoted with the gas intake main body 5. The locking engagement member 8 is pivoted with the gas intake support 6. The locking engagement member 8 is engaged with the gas intake connecting rod 7. The auxiliary unit 2 comprises an outer casing 9, an auxiliary unit main body 10, a water bottle coupler 11, a tapered ring 12, and a soda bottle 13. The tapered ring 12 is provided between the auxiliary unit main body 10 and the water bottle coupler 11. The auxiliary unit main body 10 and the water bottle coupler 11 are fixedly connected together. The auxiliary unit main body 10 is provided with a gas discharge valve 14, a switch valve 15, and a safety valve 16. The gas discharge valve 14, the switch valve 15, and the safety valve 16 are communicated with a cavity 10A on the auxiliary unit main body 10. The outer casing 9 is connected with the housing 3. The gas intake main body 5 is communicated with a gas intake assembly 17 on the auxiliary unit main body 10. A gas rod 18 connected with the gas intake assembly 17 extends into the soda bottle 13.

The housing 3 is provided with an installation hole 31.

A connecting part 91 is provided on the outer casing 9, two parallel pivoting plates 92 are provided on the connecting part, and a half shaft 921 and a positioning protrusion 922 are provided on the pivoting plate.

The soda maker further comprises a pivoting base 19 having a side opening and a top opening.

A half shaft hole 191, an operation positioning blind hole 192 and a gas discharge positioning blind hole 193 are provided on the side wall plate of the pivoting base 19.

The pivoting base 19 is fixed within the housing 3. The pivoting plate 92 passes through the installation hole 31. The half shaft 921 is pivoted with the half shaft hole 191. During operation, the positioning protrusion 922 is engaged with an operation positioning blind hole 192. An axis of the connecting part 91 is parallel to a horizontal plane. The gas discharge valve 14 is engaged with an end plate of the pivoting base 19. The switch valve 15 is engaged with the locking engagement member 8. The positioning protrusion 922 is engaged with the gas discharge positioning blind hole 193.

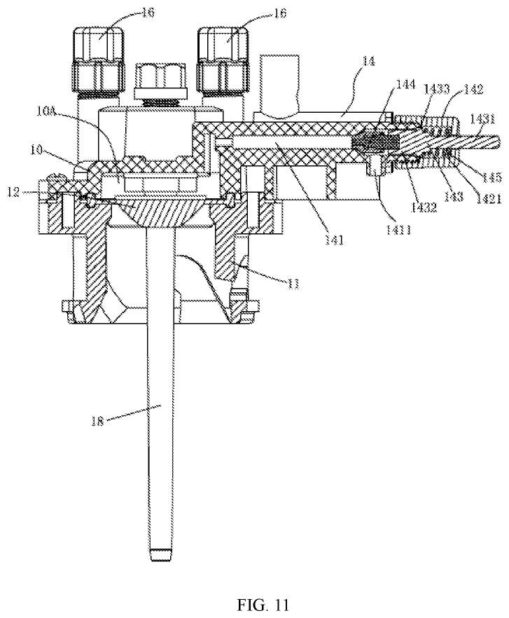

As shown in FIG. 11, the gas discharge valve 14 comprises a gas discharge valve body 141, a gas discharge valve nut 142, a gas discharge valve rod 143, a gas discharge valve core 144 and a pressure spring 145 which are provided on the auxiliary unit main body. The closed end of the gas discharge valve body 141 is provided with a valve core base and is connected with the cavity 10A of the auxiliary unit main body 10. The gas discharge valve body 141 is provided with radial gas discharge holes 411.

The gas discharge valve rod 143 comprises a driving rod part 1431, a body part 1432, a circular disc 1433 surrounding the body part and a stopper 1434 at the suspended end of the driving rod part.

The gas discharge nut 142 comprises a cavity part 1421, an internal thread part and a guide hole provided on the end plate.

The gas discharge valve core 144 is provided at the end of the body part 1432. The body part 1432 is in sliding fit with the gas discharge valve body 141. The circular disc 1433 is engaged with the end of the gas discharge valve body 141. The driving rod part 1431 extends through the pressure spring 145 and the gas discharge nut 142. The circular disc 1433 is in sliding fit with the cavity part 1421 of the gas discharge nut 142. The pressure spring 145 is in sliding fit with the circular disc 1433 and the end plate of the gas discharge nut 142. The driving rod part 1431 is in sliding fit with the guide hole. The driving rod part 1431 is embedded with a clamping groove 194 on the end plate of the pivoting base 19. The stopper 1434 is engaged with the end plate of the pivoting base 1434.

During operation, the gas discharge valve core 144 is embedded with the gas guide hole on the valve core base. The pressure spring 145 is in an automatic state.

When discharging gas, the gas discharge valve core 144 is separated from the gas guide hole on the valve core base, and the pressure spring 145 is in a compressed state.

The operation positioning blind hole 192 and the gas discharge positioning blind hole 193 are communicated through an arc-shaped guide groove.

The connecting part 91 is located in the installation hole 31, and there is a gap between the connecting part 91 and the installation hole 31.

The switch valve 15 comprises a switch valve body 151 provided on the auxiliary unit main body 10, a switch valve core base 152 provided in the switch valve body, a switch valve rod 153, a valve core 154, a pressure spring 155, a switch nut 156 and a safety gas discharge device 157 communicated with the switch valve body.

The switch valve rod 153 comprises a head part and a rod part, and the switch nut 156 comprises a cavity part, an external thread part and a valve rod hole.

The valve core 154 is provided on the head of the switch valve rod 153. The valve core 154 is engaged with the gas hole on the switch valve core base 152. The head of the switch valve core base 152 is in sliding fit with the inner cavity of the switch valve body 151. The pressure spring 155 is sleeved on the valve rod with one end engaged with the head of the switch valve rod 153 and the other end engaged with the end plate of the cavity part of the switch nut 156. The switch valve rod 153 extends out of the switch nut 156 through the valve rod hole. The switch valve rod 153 is engaged with the locking engagement member.

The safety gas discharge device 157 comprises a gas discharge cavity 1571, a safety valve core base 1572 provided at the bottom of the gas discharge cavity, a pressure relief hole 1573, a safety valve core 1574, a valve rod 1575, a pressure spring and a plug 1576.

The safety valve core 1574 is provided on the head of the valve rod 1575. The safety valve core 1574 is engaged with the safety valve core base 1572. The plug 1576 is screwed with the internal thread part at the upper part of the gas discharge cavity 1571. The pressure spring is engaged with the head of the valve rod 1575 and the internal counterbore on the plug 1576.

According to the present Patent, during operation, in the state shown in FIGS. 1 and 3, the button 1A on the main unit 1 is pressed down, the gas intake connecting rod 7 rotates, the gas intake connecting rod 7 is locked with the locking engagement member 8, and the switch valve rod 153 of the switch valve 15 abuts against the lower end of the locking engagement member 8. The gas in the carbon dioxide cylinder extends into the soda bottle 13 through the gas intake main body 5, the gas intake assembly 17 on the auxiliary unit main body 10 and the gas rod 18.

When the set pressure is reached in the soda bottle 13, the switch valve rod 153 of the switch valve 15 moves and acts on the lower end of the locking engagement member 8. The locking engagement member 8 is separated from the gas intake connecting rod 7. The gas intake connecting rod 7 is reset, thus cutting off the gas path. [00058]In the state shown in FIG. 1 and FIG. 3, the auxiliary unit 2 rotates clockwise, and the gas discharge valve rod 143 is stationary relative to the main unit 1. The gas discharge valve rod 143 compresses the pressure spring 145, and the gas discharge valve core 144 leaves the valve core base and discharges gas. Then the soda bottle 13 is removed for drinking. The auxiliary unit 2 is reset, and the gas discharge valve core 144 is attached to the valve core base.

The above is only the preferred embodiment of the present Patent. It should be pointed out that several improvements and modifications can be made without departing from the principle of the present Patent for those skilled in the art, which is also regarded as the scope of protection of the present Patent.

What is claimed is:

1. A soda maker having convenient gas intake and discharge, which comprises a main unit and an auxiliary unit, wherein the main unit comprises a housing, a base, a carbon dioxide cylinder provided within the housing, a gas intake main body provided at the top of the carbon dioxide cylinder, a gas intake support, a gas intake connecting rod, and a locking engagement member, the gas intake connecting rod is pivoted with the gas intake main body, the locking engagement member is pivoted with the gas intake support, the locking engagement member is engaged with the gas intake connecting rod; the auxiliary unit comprises an outer casing, an auxiliary unit main body, a water bottle coupler, a tapered ring, and a soda bottle, the auxiliary unit main body is provided with a gas discharge valve and a switch valve, the outer casing is connected with the housing, the gas intake main body is communicated with a gas intake assembly on the auxiliary unit main body, and a gas rod connected with the gas intake assembly extends into the soda bottle; wherein the housing is provided with an installation hole;
a connecting part is provided on the outer casing, two parallel pivoting plates are provided on the connecting part, and a half shaft and a positioning protrusion are provided on the pivoting plate;
the soda maker further comprises a pivoting base having a side opening and a top opening;
a half shaft hole, an operation positioning blind hole and a gas discharge positioning blind hole are provided on the side wall plate of the pivoting base;
the pivoting base is fixed within the housing, the pivoting plate passes through the installation hole, the half shaft is pivoted with the half shaft hole, during operation, the positioning protrusion is engaged with an operation positioning blind hole, an axis of the connecting part is parallel to a horizontal plane, the gas discharge valve is engaged with an end plate of the pivoting base, the switch valve is engaged with the locking engagement member, and the positioning protrusion is engaged with the gas discharge positioning blind hole.

2. The soda maker having convenient gas intake and discharge according to claim 1, wherein the gas discharge valve comprises a gas discharge valve body, a gas discharge valve nut, a gas discharge valve rod, a gas discharge valve core and a pressure spring which are provided on the auxiliary unit main body, the closed end of the gas discharge valve body is provided with a valve core base and is connected with the cavity of the auxiliary unit main body, and the gas discharge valve body is provided with radial gas discharge holes;
the gas discharge valve rod comprises a driving rod part, a body part, a circular disc surrounding the body part and a stopper at the suspended end of the driving rod part;
the gas discharge nut comprises a cavity part, an internal thread part and a guide hole provided on the end plate;
the gas discharge valve core is provided at the end of the body part, the body part is in sliding fit with the gas discharge valve body, the circular disc is engaged with the end of the gas discharge valve body, the driving rod part extends through the pressure spring and the gas discharge nut, the circular disc is in sliding fit with the cavity part of the gas discharge nut, the pressure spring is in sliding fit with the circular disc and the end plate of the gas discharge nut, the driving rod part is in sliding fit with the guide hole; the driving rod part is embedded with a clamping groove on the end plate of the pivoting base, and the stopper is engaged with the end plate of the pivoting base;
during operation, the gas discharge valve core is embedded with the gas guide hole on the valve core base, the pressure spring is in an automatic state;
when discharging gas, the gas discharge valve core is separated from the gas guide hole on the valve core base, and the pressure spring is in a compressed state.

3. The soda maker having convenient gas intake and discharge according to claim 1, wherein the operation positioning blind hole and the gas discharge positioning blind hole are communicated through an arc-shaped guide groove.

4. The soda maker having convenient gas intake and discharge according to claim 1, wherein the connecting part is located in the installation hole, and there is a gap between the connecting part and the installation hole.

5. The soda maker having convenient gas intake and discharge according to claim 1, wherein the switch valve comprises a switch valve body provided on the auxiliary unit main body, a switch valve core base provided in the switch valve body, a switch valve rod, a valve core, a pressure spring, a switch nut and a safety gas discharge device communicated with the switch valve body;
the switch valve rod comprises a head part and a rod part, and the switch nut comprises a cavity part, an external thread part and a valve rod hole;
the valve core is provided on the head of the switch valve rod, the valve core is engaged with the gas hole on the switch valve core base, the head is in sliding fit with the inner cavity of the switch valve body, the pressure spring is sleeved on the valve rod with one end engaged with the head of the switch valve rod and the other end engaged with the end plate of the cavity part of the switch nut, the switch valve rod extends out of the switch nut through the valve rod hole, and the switch valve rod is engaged with the locking engagement member.

6. The soda maker having convenient gas intake and discharge according to claim 5, wherein the safety gas discharge device comprises a gas discharge cavity, a safety valve core base provided at the bottom of the gas discharge cavity, a pressure relief hole, a safety valve core, a valve rod, a pressure spring and a plug;
the safety valve core is provided on the head of the valve rod, the safety valve core is engaged with the safety valve core base, the plug is screwed with the internal thread part at the upper part of the gas discharge cavity, and the pressure spring is engaged with the head of the valve rod and the internal counterbore on the plug.
